(19) United States
(12) Patent Application Publication
(10) Pub. No.: US 2018/0156063 A1
(43) Pub. Date: Jun. 7, 2018

(54) ARRANGEMENT, TURBO ENGINE AND METHOD FOR THE RECOGNITION OF A SHAFT BREAKAGE OF A SHAFT

(71) Applicant: Rolls-Royce Deutschland Ltd & Co KG, Blankenfelde-Mahlow (DE)

(72) Inventor: Rudolf LUECK, Nuthetal-Rehbruecke (DE)

(21) Appl. No.: 15/827,494

(22) Filed: Nov. 30, 2017

(30) Foreign Application Priority Data
Dec. 2, 2016 (EP) 16 202 041.6
Jul. 28, 2017 (DE) 10 2017 213 090.3

(51) Int. Cl. F01D 21/00; G01L 5/00; G01L 5/12

(52) U.S. Cl. CPC F01D 21/003; F04D 27/001; G01L 5/12; G01L 5/0019

(57) ABSTRACT

It is provided an arrangement for detecting a shaft break. The arrangement comprising a shaft, a bearing on which the shaft is mounted so as to be rotatable about a rotational axis, a force sensor which is arranged on the bearing and is configured to measure an axial force component, applied by the shaft, in parallel with the rotational axis of the shaft, and an evaluation unit which is configured to receive measured values of the force sensor and to determine, on the basis of comparison of a plurality of measured values, whether there is a change in the axial force component, in order to detect a shaft break of the shaft.

### REFERENCE TO RELATED APPLICATION

This application claims priority to European Patent Application No. 16202041.6 filed on Dec. 2, 2016 and to German Patent Application No. 10 2017 213 090.3, the entirety of which is incorporated by reference herein.

### BACKGROUND

The invention relates to an arrangement for detecting a shaft break, a turbomachine and a method for detecting a shaft break of a shaft.

When unusual loads occur on a shaft, a break of the shaft may occur. A shaft break can trigger consequential damage which can be minimized or even prevented by prompt initiation of countermeasures. In order to be able to take countermeasures after the shortest possible time, it is necessary to detect the break of the shaft quickly and reliably. In particular, if the arrangement is part of a turbomachine, for example a supply of fuel to the turbomachine can be interrupted as a countermeasure.

A mechanical system, known to the applicant from practical applications, for initiating countermeasures after a shaft break in a turbomachine uses the combination of the shaft with a coaxial reference shaft which rotates together with the shaft. Cutouts, which in the normal operating state of the shaft are not congruent, are provided in the shaft and the reference shaft. If the shaft breaks, the cutouts move into congruence with one another, and a hook or metal bar engages through the cutouts. This movement of the bar interrupts the fuel supply.

However, such mechanical solutions are heavy and have a complex design and are also arranged in the hot surroundings of the engine.

### SUMMARY

An object is to make available an improved arrangement and an improved method for detecting a shaft break, which arrangement has, in particular, a particularly simple design.

The object is achieved by means of an arrangement having features as described herein.

Accordingly, such an arrangement for detecting a shaft break has at least one shaft and at least one bearing (fixed bearing), on which the shaft is mounted so as to be rotatable about a rotational axis, and at least one force sensor or a plurality of force sensors (in particular in the form of a force sensor, or each in the form of a force sensor) and an evaluation unit. The force sensor or sensors is/are arranged on the bearing, in particular secured thereto, and configured to measure an axial force component of a force which is applied to the bearing by the shaft, wherein the axial force component is oriented along the rotational axis of the shaft. The evaluation unit is designed to receive measured values of the force sensor/force sensors with respect to the axial force component and to determine, on the basis of a comparison of at least two measured values (in particular measured values from a time profile of the measured values), whether there is a change (caused by a shaft break) in the axial force component or not, in particular whether there is a change in the orientation or direction of the axial force component and/or whether a change in the axial force component (or its absolute value) exceeds a predefined or predefineable threshold value, in order to detect a shaft break of the shaft. If the change (or its absolute value) is below the threshold value, the evaluation unit can be configured to detect that there is no shaft break of the shaft. The evaluation unit is configured to output a signal which indicates a shaft break if the evaluation unit has detected a shaft break. The time profile comprises for example at least two measured values and specifies, for example, the change in the measured values over time.

By virtue of an arrangement which is improved in this way it is possible to dispense with many movable mechanical parts, for example with a metal bar which engages in cutouts. As a result a significantly simpler design of the arrangement is possible. Furthermore, the function of the arrangement can be tested during ongoing operation of the shaft, for example by checking the measured values of the force sensor, for example by comparison with previous measured values, in particular of the force sensor.

After the detection of a shaft break, the arrangement can initiate suitable countermeasures, for example locking of a fuel supply. The initiation of the countermeasures is preferably carried out by means of the signal output in the case of a shaft break. With the described arrangement it is possible to initiate the countermeasures with a particularly short delay, which can increase the effectiveness of the measures.

The arrangement is based on the concept of detecting a change in the force which the shaft transmits to the bearing in the rotational direction of said shaft. From such a change it is possible to infer a break in the shaft. A shaft break can result for example in an axial load reversal at the bearing. The evaluation unit detects such a load reversal from the change in the axial force component, in particular from a change in the orientation of the axial force component.

The bearing can comprise a stationary bearing part and a rotatable bearing part. In this context, the rotatable bearing part can be rotated, together with the shaft, with respect to the stationary bearing part about the rotational axis of the shaft.

According to one development, the force sensor is arranged on the stationary bearing part. This permits simple connection of the force sensor to the evaluation unit.

In addition to the force sensor, the arrangement can comprise one or more further force sensors. The further force sensors can be arranged on the same bearing as the (first) force sensor. The force sensor and at least one further force sensor can be arranged on axially opposite sections or sides of the bearing, in particular of the stationary bearing part. The evaluation unit is also configured to receive measured values from the further force sensor. The evaluation unit can for example detect a shaft break of the shaft when the axial component at the (first) force sensor increases and at the same time decreases at the further force sensor (or vice versa). In this way, a particularly precise measurement is possible. One or both force sensors are for example respectively embodied as a piezoelement, as a strain gauge element (in particular in the form of a strain gauge), as a piezo-resistive element, as an acceleration sensor and/or as a distance sensor. A combination of different force sensors, for example of at least one piezoelement with at least one strain gauge element, is also possible. All the force sensors are alternately embodied in a similar way, for example are of the same type.

Overall, the arrangement can comprise an even number of (first and further) force sensors. These can be arranged on opposite sides or sections of the bearing. Specifically there can be provision that the arrangement comprises a plurality of (first) force sensors and a plurality of (further) force sensors, wherein the number of (first) force sensors can be equal to the number of further force sensors, with the result that a symmetrical measuring arrangement can be obtained.

The bearing is, for example, a ball bearing, in particular an angular ball bearing. The stationary bearing part can then be for example an outer ring of the ball bearing, or angular ball bearing. The ball bearing or angular ball bearing can engage around the shaft. Angular ball bearings are particularly suitable for transmitting forces along the rotational axis of the shaft. The force sensor can be arranged in such a way that it detects periodic forces by means of balls of the bearing which roll by. For example, the force sensor can be integrated onto or into the structure of the bearing or a bearing mount of the bearing. Since ball bearings generally comprise a plurality of balls, a change in the periodic forces owing to a shaft break can already be determined after a very short time, for example after one rotation of the shaft by only a few degrees. If a plurality of force sensors are arranged offset in the circumferential direction, this time can be reduced even further.

The evaluation unit can be configured to determine, on the basis of a comparison of at least one measured value of the force sensor with a predetermined or predeterminable comparison value, whether there is a change in the axial force component and/or in order to determine the degree of change. With this information it is possible for the evaluation unit to detect a shaft break of the shaft. The comparison value is, for example, a predefined or predefineable comparison value. Alternatively, the comparison value is a preceding measured value of the force sensor or a simultaneous or preceding measured value of the further force sensor. As a result, particularly easy determination of the change can be brought about.

The evaluation unit can comprise a device which is configured to determine extreme values of a periodic signal profile of the measured value of the force sensor or of the force sensor and of the further force sensor. If the signal profile is periodic, for example on the basis to balls, rolling past the sensor, of the bearing which is embodied as a ball bearing, in particular as an angular ball bearing, a value which can be compared better is therefore determined. This value can additionally have a particularly high level of accuracy.

According to one development, the evaluation unit is designed to determine, on the basis of a comparison of at least one extreme value with a comparison value, whether there is a change in the axial force component or not, in order to detect a shaft break of the shaft. For example, the evaluation unit detects a shaft break if there is a change, in particular a change which is greater than a predefined threshold value.

The comparison value is for example a preceding extreme value, an extreme value of the further force sensor or a predefined or predefineable threshold value.

According to a further aspect, a turbomachine is made available which comprises an arrangement according to any refinement described herein. The turbo machine or fluid kinetic machine is embodied, in particular, in the form of an aircraft engine. A particularly simple design is obtained here by using the described arrangement.

If the arrangement detects a shaft break, it can initiate suitable countermeasures, for example in order to prevent or minimize possible consequence damage, for example locking of a fuel supply, emptying of a fuel feed line via a valve by actuating the valve and/or adjusting variable vanes (VSV, variable stator vanes) to a low air throughput rate.

The turbomachine has a main flow direction. The main flow direction is oriented for example in parallel with the rotational axis. The main flow direction extends from a flow inlet of the turbomachine to a flow outlet, in particular a nozzle. The bearing is arranged upstream, with respect to the main flow direction, of a further bearing, wherein the shaft is also mounted on the further bearing so as to be rotatable about the rotational axis of said shaft. In contrast to, in particular, mechanical solutions for detecting a shaft break, the force sensor of the arrangement (which can be embodied as a deformation sensor) only requires a small amount of installation space. The force sensor can therefore be arranged at the bearing facing the flow inlet. In a turbomachine, this is usually the relatively cold side compared to the side of the flow outlet. This simplifies the design of the arrangement further, because no or fewer measures against overheating, for example of the force sensors and/or of signal lines, have to be taken.

The bearing is, for example, a fan bearing of the turbomachine which has a fan.

The object is also achieved by means of a method for detecting a shaft break of a shaft having features as described herein. The method has the following steps:
A shaft is made available which is mounted on a bearing so as to be rotatable about a rotational axis, wherein one or more force sensors is/are arranged on the bearing, said force sensor or sensors being configured to measure an axial force component, applied to the bearing by the shaft, along the rotational axis of the shaft.
Measured values of the axial force component are generated and made available by means of the force sensor/force sensors.
A time profile of the measured values which are made available is optionally determined. For this purpose, at least two measured values which are chronologically successive are used.
On the basis of a comparison of at least two measured values, in particular from the time profile of the measured values, it is determined whether there is a change in the axial force component or not, in particular whether a change in the axial force component (or its absolute value) exceeds a predefined or predefineable threshold value. A shaft break of the shaft can be detected on the basis of this result of this detection.
If a shaft break is detected, a signal which indicates the shaft break is output.

In this way it is possible to use particularly simple means to detect a shaft break of the shaft and to initiate suitable countermeasures with a particularly short delay.

An arrangement or a turbomachine according to any embodiment described herein can be used in the method.

### BRIEF DESCRIPTION OF THE DRAWINGS

The invention will be explained in relation to the exemplary embodiments illustrated in the figures.

FIG. 1 shows a schematic illustration of an aircraft engine as an embodiment of a turbomachine.

FIGS. 2A, 2B shows schematic illustrations of an arrangement for detecting a shaft break with two force sensors or deformation sensors in a cross-sectional view along the rotational axis.

FIG. 3 shows a schematic illustration of an arrangement for detecting a shaft break with a force sensor in a cross-sectional view along the rotational axis.

FIG. 4 shows a schematic illustration of an arrangement for detecting a shaft break with a force sensor in a cross-sectional view along the rotational axis.

FIGS. 5A, 5B show schematic illustrations of signal profiles of force sensors.

FIG. 6 shows a method for detecting a shaft break of a shaft.

### DETAILED DESCRIPTION

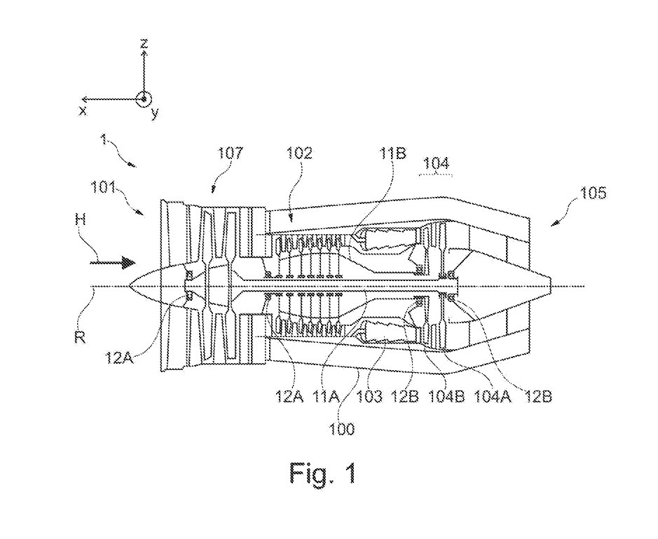

FIG. 1 shows a turbomachine 1 in the embodiment of an aircraft engine for an aircraft. The turbomachine 1 comprises a plurality of, in the present case two, shafts 11A, 11B which can rotate about a common rotational axis R. The shafts 11A, 11B are arranged within a housing 100 of the turbomachine 1. The housing 100 defines an air inflow 101 of the turbomachine 1.

An air stream flows into the turbomachine 1 through the air inflow 101. The turbomachine 1 has an axial main flow direction H. The main flow direction H runs essentially along the rotational axis R of the shafts 11A, 11B. Viewed essentially in the direction of the main flow direction H, the turbomachine 1 comprises, downstream of the air inflow 101, a fan 107, a compressor 102, a combustion chamber 103, a turbine 104 and a nozzle 105.

The turbomachine 1 is embodied here in two stages. One of the shafts 11A, 11B serves as a low-pressure shaft 11A, and the other as a high-pressure shaft 11B. The fan 107 and the low-pressure turbine 104A of the turbine 104 are fixed to the low-pressure shaft 11A. The compressor 102 and a high-pressure turbine 104B of the turbine 104 are fixed to the high-pressure shaft 11B.

The turbomachine 1 operates in a manner known per se. The fan 107 and the compressor 102 compress the air stream flowing in through the air inflow 101 and conduct it in the main flow direction H into the combustion chamber 103 for combustion. Hot combustion gases emerging from the combustion chamber 103 are expanded in the high-pressure turbine 104B and in the low-pressure turbine 104A, before they escape through the nozzle 105. The nozzle 105 ensures there is a residual expansion of the escaping hot combustion gases and that mixing occurs with secondary air, wherein the escaping air stream is accelerated.

The low-pressure turbine 104A drives the fan 107 via the low-pressure shaft 11A. The high-pressure turbine 104B drives the compressor 102 via the high-pressure shaft 11B.

Both shafts 11A, 11B are mounted by means of suitable bearings 12A, 12B so as to be rotatable with respect to the housing 100 of the turbomachine 1 about the rotational axis R. The housing 100 can be permanently connected to the aircraft.

According to FIG. 1, the low-pressure shaft 11A and the high-pressure shaft 11B each have a front bearing 12A at their respective end facing the air inflow 101. The front bearings 12A are each embodied for example as ball bearings, in particular as angular ball bearings. At their respective end facing the air outlet 105, the low-pressure shaft 11A and the high-pressure shaft 11B each have a rear bearing 12B. The rear bearings 12B are each embodied for example as roller bearings (floating bearings).

The high-pressure shaft 11B is embodied as a hollow shaft. The low-pressure shaft 11A is arranged within the high-pressure shaft 11B.

The two shafts 11A, 11B each have a drive side and an output side. The drive sides are driven by the respectively assigned turbo stages 104A, 104B. The output sides are driven by the respective drive side and drive the fan 107 or the compressor 102.

Unforesen influences, in particular excessively large forces or torques between the driveside and the output side of one of the shafts 11A, 11B can lead to a break of the shaft 11A, 11B.

The turbomachine 1 comprises at least one arrangement for detecting a shaft break in order to initiate countermeasures after a shaft break of one of the shafts 11A, 11B or a plurality of shafts 11A, 11B of the turbomachine 1, and therefore to improve the safety during the operation of the turbomachine 1. The arrangement will be explained in more detail with reference to the following figures.

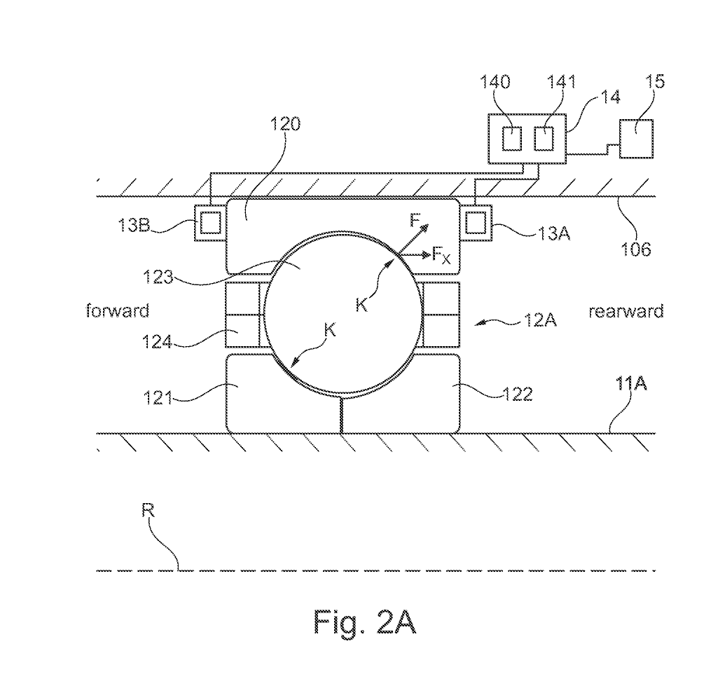

FIGS. 2A and 2B show the arrangement for detecting a break of one or more of the shafts 11A, 11B of the turbomachine 1, here using the example of the low-pressure shaft 11A, wherein the following statements also apply correspondingly to the high-pressure shaft 11B or generally to one or more random shafts 11A, 11B of the turbomachine 1.

The low-pressure shaft 11A is mounted on the bearing 12A so as to be rotatable with respect to an engine-fixed component 106 about the rotational axis R. The bearing 12A is embodied here as a fan bearing, wherein other arrangements are also possible. As illustrated in FIG. 1, the bearing 12A is arranged adjacent to the fan 107. The engine-fixed component 106 is for example fixedly connected to the housing 100 of the turbomachine 1 and/or is fixedly connected or can be connected to the aircraft.

The arrangement comprises two sensors, here two force sensors 13A, 13B (the force sensors can be, in particular, sensors which are designed to measure a deformation) which are each operatively connected to an evaluation unit 14, in the example shown by means of a signal conductor in each case. The arrangement optionally comprises more than two sensors.

The bearing 11A comprises a stationary bearing part in the form of an outer ring 120 and at least one rotatable bearing part, here two rotatable bearing parts in the form of a first inner ring part 121 and a second inner ring part 122. The outer ring 120 is fixedly connected to the engine-fixed component 106, in particular attached thereto. The inner ring parts 121, 122 are connected fixedly (in particular in a rotationally fixed fashion) to the low-pressure shaft 11A, preferably attached thereto. The bearing 11A is embodied as an angular ball bearing with a plurality of balls 123. A cage 124 holds the balls 123 at a suitable distance from one another.

In some engines, an axial load is directed onto the bearing 12A which serves as a fan bearing, in particular at rotational speeds starting from an idling rotational speed, in the direction of the turbine 104. This case is considered here, wherein however there are also turbomachines with which in a nominal case the axial load on the fan bearing is directed forward, that is to say in the direction of the air inlet. The described arrangement can also be used for such turbomachines, wherein only the described axial forces point in the opposite direction.

The axial load of the low-pressure shaft 11A on the bearing 12A results in an axial force component Fx for each ball 123 of the bearing 12A. The axial force component Fx is oriented in parallel with the rotational axis R. Together with radially directed forces, for example centrifugal forces, on the balls 123, a force F is produced which is applied by each of the balls 123 onto the outer ring 120. The first inner ring part 121 makes contact with the balls 123 in each case at a contact region K at which the axial load is introduced into the balls 123 by the low-pressure shaft 11A. On the opposite side of the balls 123, these make contact with the outer ring 120, in each case at an outer contact region K at which each of the balls 123 introduces the force F into the outer ring 120 with the axial force component Fx.

A first force sensor 13A of the two force sensors 13A, 13B of the arrangement in the example according to FIGS. 2A, 2B is arranged on the bearing 12A in such a way that it can measure a measured value for the axial force component Fx, for example by deforming the bearing 12A by means of a ball 123 which rolls past on the force sensor 13A, 13B. The magnitude of the axial force component Fx influences the measured value of the force sensor 13A. In the example according to FIGS. 2A, 2B, the first force sensor 13A is arranged on the side (end side) of the bearing 12A directed downstream in the main flow direction H. The first force sensor 13A can for example be input into the material of the outer ring 120 or be arranged on an outer surface thereof. The first force sensor 13A is preferably attached to the outer ring or embedded therein.

On the side opposite (in particular axially opposite) the first sensor 13A, a second force sensor 13B of the two force sensors 13A, 13B is arranged. Since, in the example according to FIGS. 2A, 2B, the first force sensor 13A is arranged on the side of the bearing 12A directed downstream, the second force sensor 13B is arranged there on the side (end side) of the bearing 12A directed upstream in the main flow direction H.

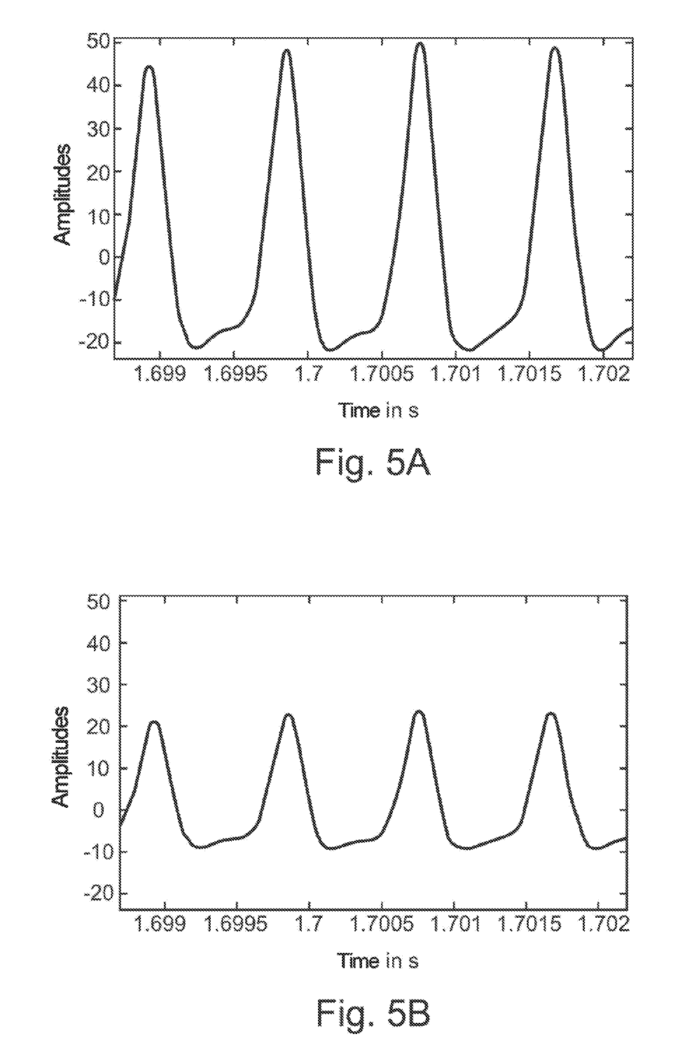

FIG. 5A shows a possible time profile of a plurality of measured values of the first force sensor 13A during intended operation of the turbomachine 1. On the X axis the time is plotted, and on the Y axis the amplitudes of the measured values are plotted. The amplitudes are specified in random units. The plurality of individual measured values is connected to form one continuous line which indicates the profile of the measured values. Whenever one of the balls 123 rolls past the force sensor 13A, it applies the force K to the part of the outer ring 120 lying between the ball 123 and the force sensor 13A, which brings about a change in the amplitude of the measured value of the force sensor 13A. In this context, the force sensor 13A senses the force for example on the basis of the deformation of the outer ring 120 by the ball 123. As a result, a periodic profile of the measured values of the force sensor 13A is produced. The periodic profile of the measured values of the force sensor 13A has maximum values or peaks at regular time intervals. The length of a signal period depends on the rotational speed of the low-pressure shaft 11A.

FIG. 5B shows a possible time profile of a plurality of measured values of the second force sensor 13B during the intended operation of the turbomachine 1 in an illustration corresponding to FIG. 5A. The second force sensor also comprises a periodic profile of the measured values as a result of the rolling past of the balls 123. Compared to the amplitudes of the measured values of the first force sensor 13A which are shown in FIG. 5A, the amplitudes of the measured values of the second force sensor 13B are, however, smaller. For example, the maximum values of the profile of the measured values of the second force sensor 13B are only less than 60% of the maximum values of the profile of the measured values of the first sensor 13A, in particularly only less than 20%.

If the low-pressure shaft 11A breaks, this brings about a (in particular sudden) change in the axial force component Fx. For example, a force of the fan 107 which is directed counter to the main flow direction H is no longer outweighed by the low-pressure turbine 104A which applies an opposing force. As a result, the ratios of the values of the two force sensors 13A, 13B are reversed. For example, after the shaft break, the profile of the measured values of the first force sensor 13A no longer corresponds to the profile shown in FIG. 5A but instead to that according to FIG. 5B and after the shaft break the profile of the measured values of the second force sensor 13B no longer corresponds to the profile generated in FIG. 5B but rather to that according to FIG. 5A. Expressed in general terms, as a result of the shaft break the profile of the measured values of the first force sensor 13A can be shifted to relatively low values, and the profile of the measured values of the second force sensor 13B can be shifted to relatively high values.

This change in the profile of the measured values therefore indicates a change in the axial force component Fx. The change in the axial force component Fx indicates in turn a shaft break of the low-pressure shaft 11A, for example if said axial force component Fx exceeds a predefined absolute value. The evaluation unit 14 is designed to detect this change on the basis of the profile of the measured values of one of the force sensors 13A, 13B or of both force sensors 13A, 13B. If the evaluation unit 14 senses such a change, it detects the shaft break.

For example, the evaluation unit 14 detects a shaft break at a reversal of a ratio of a measured amplitude value of the first force sensor 13A with respect to a measured amplitude value of the second force sensor 13B.

The evaluation unit 14 optionally comprises an extreme value determiner 140, which can determine extreme values, in particular the maximum values of the profiles of the measured values of the two force sensors 13A, 13B and determines them during the use of the arrangement. A comparator 141 of the evaluation unit 14 compares individual measured values and/or extreme values, in particular maximum values of the measured values of the first force sensor 13A with those of the second force sensor 13B (or of a group of force sensors, in particular in the form of deformation sensors or acceleration sensors, with those of a further group of force sensors, in particular in the form of deformation sensors or acceleration sensors). Alternatively or additionally, the comparator 141 compares individual measured values and/or extreme values, in particular maximum values of the measured values of one of the force sensors 13A, 13B or of both force sensors 13A, 13B with preceding measured values and/or extreme values, in particular maximum values. When a threshold value for the change between the values is exceeded, the evaluation unit 14 can detect a shaft break of the low-pressure shaft 11A.

For example, the evaluation unit 14 is designed to detect a shaft break if individual values and/or extreme values, in particular maximum values of the measured values of the first force sensor 13A drop by a predetermined value or a predetermined portion, and those of the second force sensor 13B increase (in particular simultaneously) by a predetermined value or a predetermined portion.

In reaction to the detection of a shaft break, the evaluation unit 14 can output a signal which indicates the shaft break, for example an alarm signal and/or can initiate countermeasures, for example interrupt a fuel supply. For this purpose, the evaluation unit is operatively connected to a fuel feed controller 15 of the turbomachine 1 in the case of the arrangement according to FIGS. 2A, 2B (for example by means of suitable signal conductors). Alternatively or additionally, further countermeasures can be initiated, such as for example adjustment of variable guide vanes to a low throughput rate and/or emptying of a fuel feed line or a valve by actuating this valve.

The arrangement can also optionally comprise more than two force sensors 13A, 13B, in particular a plurality of pairs of in each case a first and a second force sensor 13A, 13B. The evaluation unit 14 can then receive and evaluate measured values of the plurality of pairs. In this way, even greater measuring accuracy is possible.

The force sensors 13A, 13B or further force sensors can also alternatively or additionally be arranged on the bearing 12A of the high-pressure shaft 11B and operatively connected to the evaluation unit 14, in order (also) to detect a shaft break of the high-pressure shaft 11B. In turbomachines with three shafts, a corresponding operative connection is, of course, also possible to a bearing of a medium-pressure shaft.

One force sensor or both force sensors 13A, 13B are for example each embodied as a piezo-element, as a strain gauge, as a piezo-resistive element, as an acceleration sensor and/or as a distance sensor which measures the axial position of the cage 124 or the axial position of the balls 123.

The evaluation unit 14 can additionally be designed to detect damage to the bearing 11A, for example if it detects oscillations at a predetermined frequency in the course of the measured values of one or more of the force sensors 13A, 13B. In addition, the evaluation unit 14 can for example comprise a filter and/or a frequency analyzer. In addition, the evaluation unit 14 can be designed to determine thrust of the turbomachine 1, in particular the thrust generated by the fan 107.

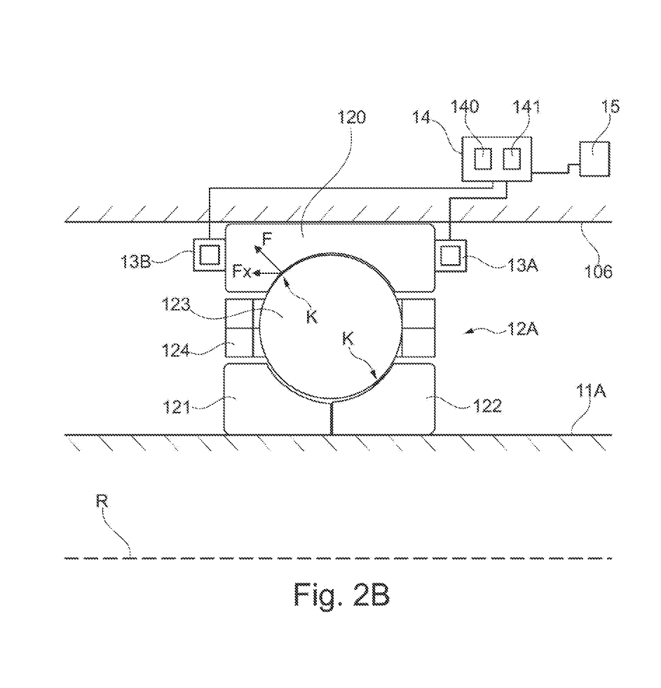

FIG. 3 shows an arrangement for detecting a shaft break which differs from the arrangement shown in FIGS. 2A and 2B in that only one force sensor 13A is provided. According to FIG. 3, said force sensor 13A is provided on the downstream-directed end side of the bearing 12A. The evaluation unit 14 detects a change in the axial force component on the basis of a change in the profile of the measured values of the force sensor 13A, in particular a rise or fall in the amplitude, for example of determined maximum values. This can be done by comparison with preceding measured values or predetermined reference values. The evaluation unit 14 detects a shaft break for example by virtue of the fact that the change in the axial force component Fx exceeds or undershoots a predetermined threshold value.

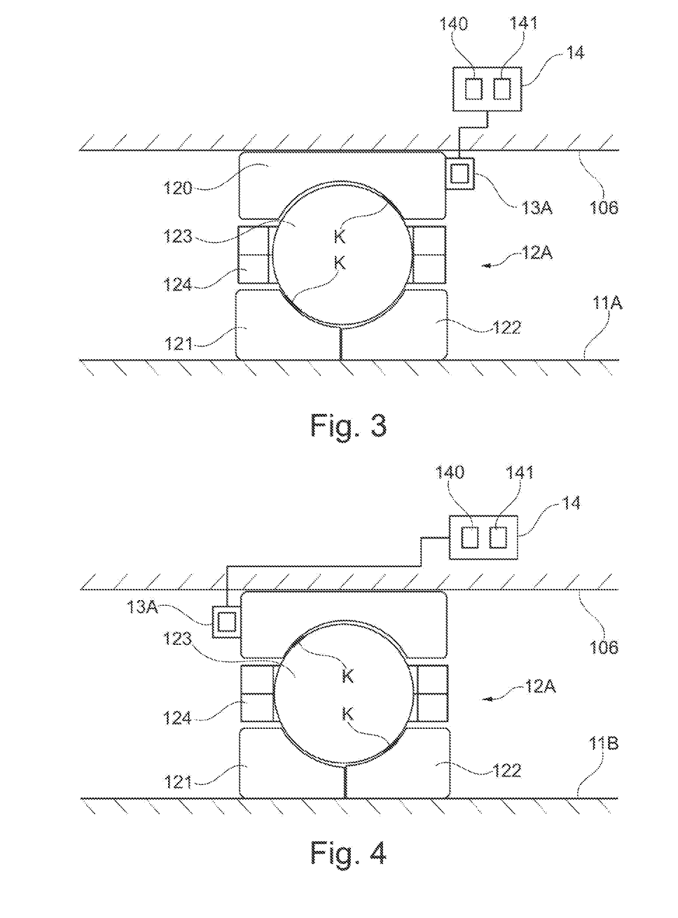

FIG. 4 shows an arrangement for detecting a shaft break, which arrangement differs from the arrangement shown in FIG. 3 in that the one force sensor 13A is arranged on the upstream-directed end side of the bearing 12A. The evaluation unit 14 detects a change in the axial force component on the basis of a change in the profile of the measured values of the force sensor 13A, in particular a rise or fall in the amplitude, for example of determined maximum values. In addition, according to FIG. 4 the force sensor 13A is arranged on the (front) bearing 12A of the high-pressure shaft 11B.

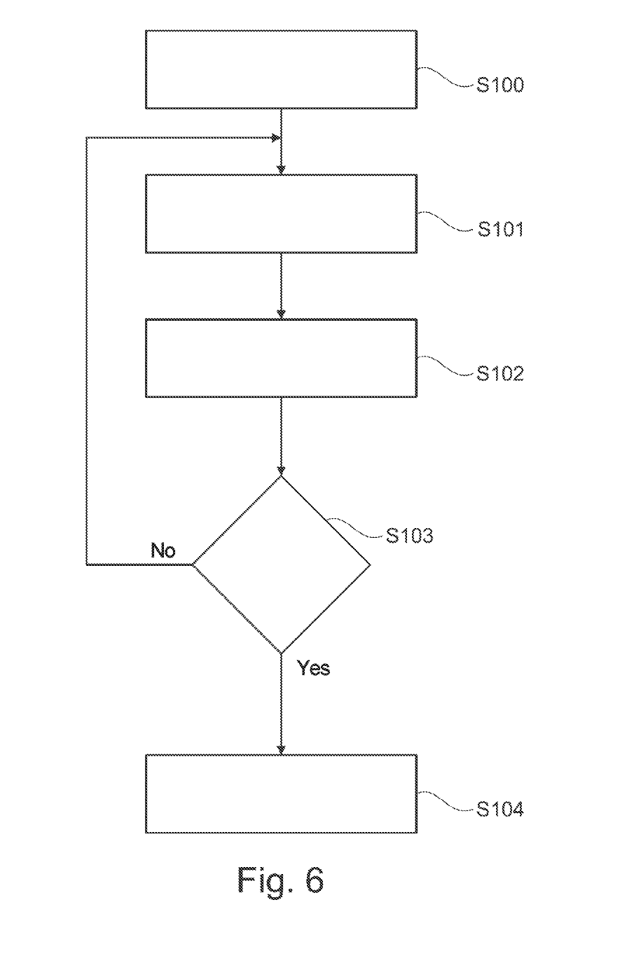

FIG. 6 shows a method for detecting a shaft break of a shaft, in particular of a shaft 11A, 11B of the turbomachine 1 according to FIG. 1, in particular using an arrangement according to FIGS. 2A, 2B, according to FIG. 3 or according to FIG. 4. The method comprises the following steps.

In step S100, a shaft 11A, 11B which is mounted on a bearing 12A so as to be rotatable about a rotational axis R is made available, wherein at least one force sensor 13A, in particular two force sensors 13A, 13B, are arranged on the bearing 12A, said force sensor or force sensors 13A, 13B is/are configured to measure an axial force component Fx, applied by the shaft 11A, 11B, along the rotational axis R of the shaft 11A, 11B.

In step S101, measured values which are indicative of the axial force component Fx are generated by means of the force sensor or force sensors 13A, 13B.

In step S102, a plurality of measured values which can originate from the same force sensor or from different force sensors 13A, 13B are compared with one another. For example, a time profile of the measured values of the once force sensor 13A or of each of the force sensors 13A, 13B is determined, which can be done for example by sensing a plurality of chronologically successive measured values of the same force sensor 13A, 13B. The comparison and/or the determination of the time profile are/is carried out, in particular, by means of the evaluation unit 14 which receives the measured values from the force sensor or force sensors 13A, 13B. The comparison optionally comprises a difference-forming operation between two measured values.

In step S103, it is determined, in particular by means of the evaluation unit 14, on the basis of the comparison of the measured values, in particular on the basis of the time profile of the measured values, whether there is a change in the axial force component Fx. As a result, a shaft break of the shaft 11A, 11B can be detected, for example by means of the evaluation unit 14, in particular if the change exceeds or undershoots a specific absolute value or threshold value. In the case of a comparison of measured values of various force sensors 13A, 13B, a shaft break is detected for example by virtue of the fact that the measured value of the force sensor 13A which is arranged further forward (toward the fan 107) has a higher amplitude than the measured value of the force sensor 13B which is arranged further toward the rear. In an alternative or additional comparison of chronologically successive measured values (of the same force sensor or of different force sensors) in a time profile, a shaft break is detected for example by virtue of the fact that the measured values experience, over the chronological profile, a change which exceeds a predetermined threshold value.

If it is determined in step S103 that there is no shaft break, the method returns to step S101.

If it is determined in step S103 that there is a shaft break, the method proceeds to step S104. In step S104, countermeasures or protective measures are initiated in order to alleviate the consequences of the shaft break. For example, a fuel supply of the turbomachine 1 is throttled or interrupted. For this purpose, a signal which indicates the shaft break is output.

With the described turbomachine 1, the described arrangements and the described method, continuously monitoring of the measured values of the force sensor 13A or of the force sensors 13A, 13B is possible, in particular by the evaluation unit 14. In this context, the undisrupted periodic profile is sensed by the balls 123 which roll past. This in turn permits the satisfactory functioning of the arrangement for detecting a shaft break which is capable of being checked during ongoing operation of the turbomachine 1.

A further advantage is that the force sensors 13A, 13B can be arranged on a front bearing 12A, in particular on the fan bearing. In the region of the front bearing 12A significantly lower temperatures are generally present than in the region of a rear bearing 11B, with the result that the force sensors 13A, 13B do not have to be protected, or only have to be protected to a small degree, against heat and temperature-sensitive types of force sensor can also be used.

The described arrangements can optionally also be used to measure the axial load on the shaft, in particular the low-pressure shaft 11A, for example for controlling the thrust and/or for detecting degradation.

### LIST OF REFERENCE SYMBOLS

1 Turbomachine
100 Housing
101 Air inflow
102 Compressor
103 Combustion chamber
104 Turbine
104A Low-pressure turbine
104B High-pressure turbine
105 Nozzle
106 Engine-fixed component
107 Fan
11A Shaft (low-pressure shaft)
11B Shaft (high-pressure shaft)
12A Bearing
12B Further bearing
120 Outer ring (stationary bearing part)
121 First inner ring part (rotatable bearing part)
122 Second inner ring part (rotatable bearing part)
123 Ball
124 Cage
13A Force sensor
13B Further force sensor
Evaluation unit
140 Extreme value determiner
141 Comparator
Fuel feed controller
F Force
Fx Axial force component
H Main flow direction
K Contact region
R Rotational axis

1. An arrangement for detecting a shaft break, comprising:
a shaft,
a bearing on which the shaft is mounted so as to be rotatable about a rotational axis,
one or more force sensors, in particular deformation sensors, which are arranged on the bearing and are/is configured to measure an axial force component, applied by the shaft, in parallel with the rotational axis of the shaft, and
an evaluation unit which is configured to receive measured values of the force sensor or force sensors and to determine, on the basis of a comparison of a plurality of measured values, in particular of a time profile of the measured values, whether there is a change in the axial force component, in order to detect a shaft break of the shaft, and which evaluation unit is configured to output a signal which indicates a shaft break if said evaluation unit has detected a shaft break.

2. The arrangement according to claim 1, wherein the bearing has a stationary bearing part and a rotatable bearing part, wherein the rotatable bearing part can be rotated, together with the shaft, with respect to the stationary bearing part about the rotational axis of the shaft.

3. The arrangement according to claim 2, wherein the force sensor is arranged on the stationary bearing part.

4. The arrangement according to claim 3, further comprising a further force sensor which is arranged on the bearing, wherein the force sensor and the further force sensor are arranged on axially opposite sections of the stationary bearing part.

5. The arrangement according to claim 4, wherein a plurality of force sensors and a plurality of further force sensors are provided, wherein the number of force sensors is equal to the number of further force sensors.

6. The arrangement according to claim 1, wherein the bearing is an angular ball bearing.

7. The arrangement according to claim 1, wherein the evaluation unit is configured to determine, on the basis of a comparison of at least one measured value of the force sensor with a predetermined comparison value, whether there is a change in the axial force component, in order to detect a shaft break of the shaft.

8. The arrangement according to claim 1, wherein the evaluation unit comprises a means for determining extreme values of a periodic signal profile of the measured values of the force sensor or of the force sensor and of a further force sensor.

9. The arrangement according to claim 8, wherein the evaluation unit is configured to determine, on the basis of a comparison of at least one extreme value with a comparison value, whether there is a change in the axial force component, in order to detect a shaft break of the shaft.

10. The arrangement according to claim 9, wherein the comparison value is a preceding extreme value, an extreme value of a further force sensor or a predefined or predefineable threshold value.

11. A turbomachine, in particular in the form of an aircraft engine, comprising an arrangement according to claim 1.

12. The turbomachine according to claim 11, comprising a main flow direction, wherein the bearing is arranged upstream, with respect to the main flow direction, of a further bearing on which the shaft is mounted so as to be rotatable about its rotational axis.

13. The turbomachine according to claim 11, wherein the bearing is a fan bearing of the turbomachine.

14. A method for detecting a shaft break of a shaft, having the following steps:
Making available a shaft which is mounted on a bearing so as to be rotatable about a rotational axis, wherein one or more force sensors, in particular deformation sensors, are arranged on the bearing, and said force sensor or sensors (13A, 13B) is or are configured to measure an axial force component, applied by the shaft, in parallel with the rotational axis of the shaft;
Generating measured values with respect to the axial force component by means of the force sensor or sensors;
Determining, on the basis of a comparison of a plurality of measured values, in particular of a time profile of the measured values, whether there is a change in the axial force component, in order to detect a shaft break of the shaft; and
Outputting a signal which indicates a shaft break if a shaft break has been detected.
